(19) United States
(12) Patent Application Publication
(10) Pub. No.: US 2021/0190147 A1
(43) Pub. Date: Jun. 24, 2021

(54) SEALED ROLLING BEARING AND METHOD FOR OPERATING A ROLLING BEARING

(71) Applicant: Schaeffler Technologies AG & Co. KG, Herzogenaurach (DE)

(72) Inventors: Thomas Nogueira da Silva, Piedade (BR); Welington Adriano Ferreira Santos, Sorocaba (BR); Fabio Luis Vieira, Sorocaba (BR)

(73) Assignee: Schaeffler Technologies AG & Co. KG, Herzogenaurach (DE)

(21) Appl. No.: 16/769,258

(22) PCT Filed: Nov. 9, 2018
(86) PCT No.: PCT/DE2018/100908

§ 371 Date: Jun. 3, 2020

(30) Foreign Application Priority Data
Dec. 7, 2017 (DE) 10 2017 129 123.7

(51) Int. Cl. F16C 33/78; F16C 19/08

(52) U.S. Cl. CPC F16C 33/7863; F16C 19/08; F16C 2310/00; F16C 33/7826; F16C 33/7866

(57) ABSTRACT

A rolling bearing includes a first bearing ring, a second bearing ring, and a seal. The seal includes a metallic thrust washer and a sealing washer. The metallic thrust washer is attached to the first bearing ring and includes a first protuberance. The sealing washer is attached to the second bearing ring and a metallic reinforcing ring with a second protuberance that interacts with the first protuberance in the form of a metal-to-metal contact as a function of load, and a first sealing lip. The first protuberance and the second protuberance may be designed as knobs.

### CROSS-REFERENCE TO RELATED APPLICATIONS

This application is the United States National Phase of PCT Appln. No. PCT/DE2018/100908 filed Nov. 9, 2018, which claims priority to German Application No. DE102017129123.7 filed Dec. 7, 2017, the entire disclosures of which are incorporated by reference herein.

### TECHNICAL FIELD

The disclosure relates to a rolling bearing with at least one seal. The disclosure further relates to a method for operating a sealed rolling bearing.

### BACKGROUND

A generic rolling bearing is known for example from DE 10 2014 208 691 A1. A seal of this rolling bearing includes a bearing race, usually also referred to as a thrust washer, which is held on a bearing ring of the rolling bearing. The seal also includes a sealing ring which is attached to the other bearing ring of the rolling bearing. The sealing ring, i.e., a sealing washer, has a metallic support ring and a plurality of sealing lips made of elastomer material.

The design of seals as a cassette seal is also fundamentally known. In this context, reference is made, for example, to documents DE 10 2012 207 688 A1, DE 10 2012 204 620 A1, WO 2015/120831 A1 and EP 1 963 697 B1.

A sealed bearing arrangement for an agricultural device is disclosed, for example, in DE 10 2012 207 848 A1. In this case, the bearing is designed as a double-row ball bearing.

### SUMMARY

In a basic concept known per se, the rolling bearing has at least one seal, which includes a metal thrust washer attached to a first bearing ring of the rolling bearing and a sealing washer attached to the second bearing ring. The sealing washer has a metallic reinforcing ring and at least one sealing lip made of an elastomer material.

According to the disclosure, the thrust washer and the reinforcing ring have protuberances which cooperate with one another in the form of a metal-metal contact in a manner dependent on the mechanical load on the rolling bearing. In an example embodiment, there is at least temporary contact between the thrust washer and the reinforcing ring in operating phases of high mechanical stress, based on a specific direction of loading, whereas in other operating phases the thrust washer is completely spaced apart from the reinforcing ring. The contacts between the thrust washer and the reinforcing ring that occur under specified operating conditions lead to intended vibrations within these operating phases. This forced vibration releases dirt accumulations so that they cannot get into the interior of the rolling bearing and the function of the seal is maintained without restriction. In typical applications, the total duration of those operating phases in which the thrust washer contacts the reinforcing ring is shorter than the operating time in which there is no contact between the thrust washer and the reinforcing ring. The forced metal-metal contact between the thrust washer and the reinforcing ring thus has a minor effect on the friction of the rolling bearing.

According to one possible embodiment, the protuberances of both the thrust washer and the reinforcing ring are designed as knobs. The knobs of one ring may be aligned in the direction of the other ring. This means that in the event of contact between the thrust washer and the reinforcing ring, a protuberance of the thrust washer contacts a protuberance of the reinforcing ring which is also designed as a knob. At least twelve protuberances may be distributed both on the circumference of the thrust washer and on the circumference of the reinforcing ring.

The seal of the rolling bearing may be designed in such a way that the thrust washer is completely spaced apart from the reinforcing ring in the load-free state. In this state there is therefore no metal-to-metal contact between two components of the seal which are moved relative to one another. In an example embodiment, the seal is a contact seal.

In an example embodiment, the thrust washer is located on an inner side of the seal, that is to say on the side of the seal facing the rolling elements. The sealing disc may have two sealing lips, whereby at least in some of the possible operating states, e.g., in a mechanically loaded state, one of the sealing lips contacts the thrust washer and the other sealing lip contacts only one of the bearing rings.

Both the thrust washer and the reinforcing ring can be efficiently manufactured as a sheet metal part. In this case, the protuberances, in the form of knobs, for example, can be produced in a single method step together with the shaping of the respective annular component, i.e., the thrust washer or the reinforcing ring. In an example design, the wall thickness of the reinforcing ring is less than the wall thickness of the thrust washer.

The rolling bearing can have rolling elements of any shape, for example rollers, needles or balls, and any number of rows of rolling elements. For example, the rolling bearing is a double-row ball bearing. In example configurations, the rolling bearing is primarily intended for the transmission of radial forces.

Regardless of the type and arrangement of the rolling elements, the rolling bearing can be used in the following operating states:

In an operating state of the rolling bearing with low mechanical load, the bearing rings rotate relative to one another and the thrust washer does not touch the reinforcing ring,

In an operating state with increased mechanical load, the reinforcing ring contacts the thrust washer in such a way that the shape of the reinforcing ring and thrust washer generates oscillating relative movements between the reinforcing ring and the thrust washer, the frequency of which is higher than the speed of the rolling bearing.

If the rolling bearing is a radial bearing, the oscillations forced in the rolling bearing by contact between the thrust washer and the reinforcing ring may be oriented primarily in the axial direction of the rolling bearing. The operating state in which the armoring ring contacts the thrust washer can be forced between the bearing rings by axial forces.

The rolling bearing is suitable for use in agricultural machines. This can be both mobile and stationary machines. The rolling bearing can also be used in industrial systems, particularly in areas with high levels of contamination.

### BRIEF DESCRIPTION OF THE DRAWINGS

An exemplary embodiment of the disclosure is explained in more detail below with reference to a drawing. In the following:

FIG. 1 shows a rolling bearing in a sectional view,

FIGS. 2 and 3 show a detail of the rolling bearing in different operating states,

FIG. 4 shows the rolling bearing in an exploded view,

FIG. 5 shows the rolling bearing in perspective view,

FIGS. 6 to 8 show a thrust washer of a seal of the rolling bearing, and

FIG. 9 shows a schematic sectional view of a portion of the thrust washer and a reinforcing ring of the seal of the rolling bearing.

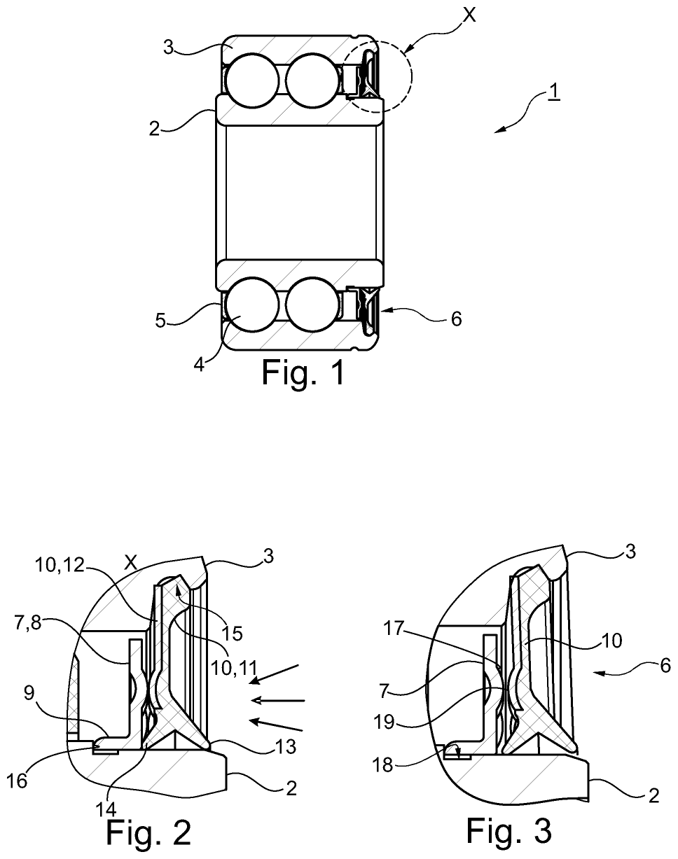

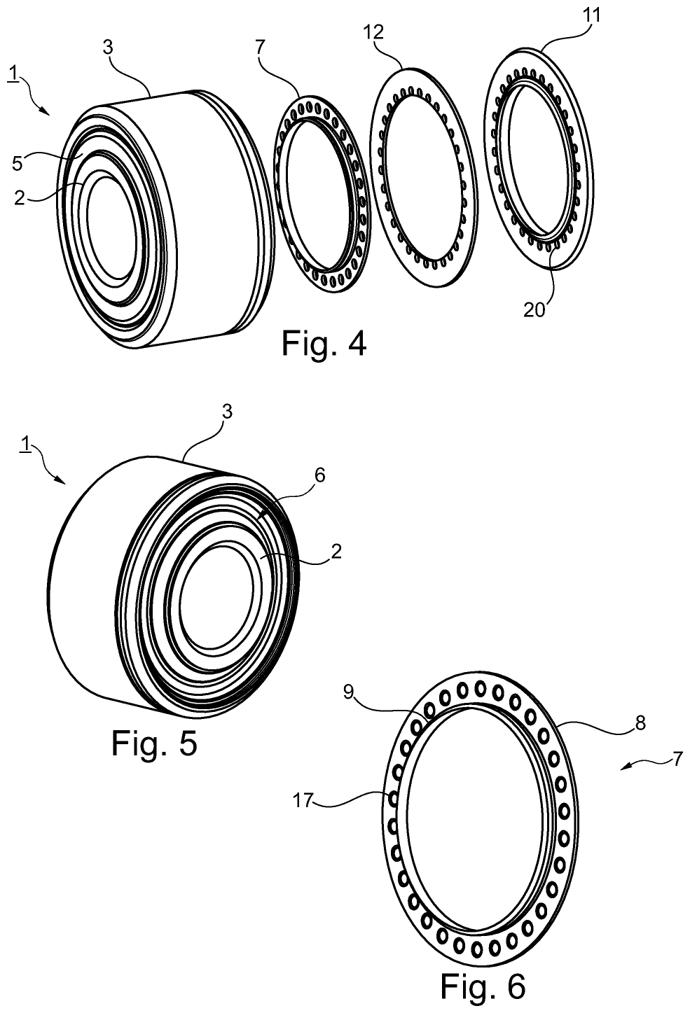

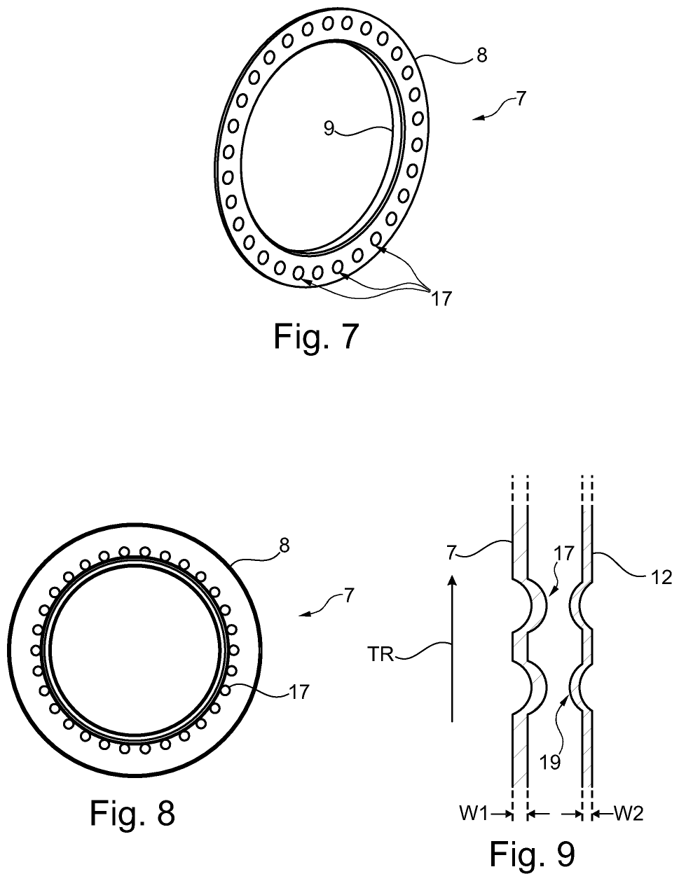

### DETAILED DESCRIPTION

A rolling bearing identified overall by the reference number 1 is a double-row ball bearing. The ball bearing 1 includes two bearing rings 2, 3, namely an inner ring 2 and an outer ring 3, between which balls 4 roll, which are guided in a cage 5. The rolling bearing 1 further includes a seal 6, which will be discussed in more detail below. In the exemplary embodiment there is a seal 6 on exactly one end face of the rolling bearing 1. A correspondingly designed seal 6 could also be located on the second end face.

The seal 6 includes a thrust washer 7, which is held on the inner ring 2. The thrust washer 2 is made of sheet metal and, as can be seen, for example, from FIGS. 2 and 3, has an angled shape in cross section. A disc section 8 of the thrust washer 7 lies essentially in a plane which is oriented normal to the central axis of the rolling bearing 1. The inner edge of disc section 8 is connected to a flange 9, which describes a cylindrical shape. The flange 9 rests on an annular shoulder 16 of the inner ring 2. Shoulder 16 represents a boundary of an annular groove 18, the width measured in the axial direction being less than the width of the flange 9 measured in the same direction. Outside the annular groove 18, the flange 9 lies flat on the outer circumferential surface of the inner ring 2. The disc section 8 adjoining the flange 9 extends over the largest part of the annular gap which is formed between the outer circumferential surface of the inner ring 2 and the inner circumferential surface of the outer ring 3, but does not contact the outer ring 3 in any operating state.

The thrust washer 7 is located on the inner side of the seal 6, that is, on the side of the seal 6 facing the rolling elements 4. A sealing disc 10, which is held in a groove 15 in the outer ring 3, acts as the outer component of the seal 6 facing an end face of the bearing rings 2, 3. In contrast to the thrust washer 7, the sealing washer 10 is a part which includes a plurality of materials. A support ring 12, also referred to as a reinforcing ring, is made of sheet steel like the thrust washer 7. The reinforcing ring 12 is firmly connected to an elastomer ring 11 which has two sealing lips 13, 14.

The interaction between the thrust washer 7 on the one hand and the sealing washer 10 on the other hand depends on the extent to which axial forces act between the bearing rings 2, 3. Such axial forces are illustrated by arrows in FIG. 2. The axial forces which can occur during the operation of the rolling bearing 1, which is mainly designed as a radial bearing, result in the thrust washer 7 contacting the reinforcing ring 12. Here, knobs 17, which are distributed on the circumference of the disc section 8, touch knobs 19, which are distributed in an analogous manner on the circumference of the reinforcing ring 12. The various knobs 17, 19 face each other, so that in the event of contact between the thrust washer 7 and the reinforcing ring 12, two convex contours formed by the knobs 17, 19 abut one another. In the exemplary embodiment, the thrust washer 7 has a total of thirty knobs 17. The reinforcing ring 12 has thirty knobs 19 in an analogous design. The knobs 17, 19 are thus spaced apart from one another on the thrust washer 7 or on the reinforcing ring 12 at an angle of 12°. Knobs 20 can be seen on the elastomer ring 11, the shape of which is adapted to the shape of the knobs 19.

In the operating state according to FIG. 2, the sealing lip 13 contacts only the inner ring 2, while the sealing lip 14 contacts both the inner ring 2 and the thrust washer 7. The total of sixty knobs 17, 19 of the thrust washer 7 and the reinforcing ring 12 ensure that the rotation of the inner ring 2 relative to the outer ring 3 leads to a rapidly oscillating axial movement between the bearing rings 2, 3. The frequency of this rapidly oscillating, vibrating axial movement is higher than the speed of the rolling bearing 1, in each case in Hz. If the seal 6 is loaded with dirt, the forced vibration removes this dirt from the seal 6. The likelihood of dirt entering the interior of the rolling bearing 1 or of damage to the seal 6 is thus reduced in comparison with conventionally constructed seals.

Details of the thrust washer 7 and the reinforcing ring 12 are shown in FIG. 9. Herein, the tangential direction in which the thrust washer 7 is moved relative to the reinforcement ring 12 is identified as TR. The wall thickness of the thrust washer 7 designated W1 is greater than the wall thickness of the reinforcing ring 12 labeled W2. The operating state of the rolling bearing 1 according to FIG. 9 corresponds to the state shown in FIG. 3. Here, the reinforcing ring 12 is completely lifted off the thrust washer 7, so that no vibrations are generated by the seal 6. This operating state is present for most of the total operating time of the rolling bearing 1.

### REFERENCE NUMERALS

1 Rolling Bearings, Ball Bearings

2 Inner Ring

3 Outer Ring

4 Rolling Elements, Ball

5 Cage

6 Seal

7 Metal Disc, Thrust Washer

8 Disc Section

9 Flange

10 Sealing Washer

11 Elastomer Ring

12 Support Ring, Reinforcing Ring

13 Sealing Lip

14 Sealing Lip

15 Groove

16 Shoulder

17 Protuberance, Knob

18 Annular Ring

19 Protuberance, Knob

20 Protuberance

TR Tangential Direction

W1, W2 Wall Thickness

1.-10. (canceled)

11. A rolling bearing comprising:
a first bearing ring;
a second bearing ring; and
a seal comprising:
a metallic thrust washer attached to the first bearing ring and comprising a first protuberance; and
a sealing washer attached to the second bearing ring and comprising:
a metallic reinforcing ring with a second protuberance that interacts with the first protuberance in the form of a metal-to-metal contact as a function of load; and
a first sealing lip.

12. The rolling bearing of claim 11, wherein the first protuberance and the second protuberance are designed as knobs.

13. The rolling bearing of claim 11, wherein:
the metallic thrust washer comprises at least 12 circumferentially distributed first protuberances; and
the metallic reinforcing ring comprises at least 12 circumferentially distributed second protuberances.

14. The rolling bearing of claim 11, wherein the seal is designed such that the metallic thrust washer is completely spaced apart from the metallic reinforcing ring in a load-free state.

15. The rolling bearing of claim 11, wherein the metallic thrust washer is located on an inner side of the seal.

16. The rolling bearing of claim 15, wherein:
the sealing washer comprises a second sealing lip; and
when the load exceeds a predefined limit and the first protuberance interacts with the second protuberance:
the first sealing lip contacts the metallic thrust washer; and
the second sealing lip only contacts the inner bearing ring or the outer bearing ring.

17. The rolling bearing of claim 11, wherein:
the metallic thrust washer comprises a first wall thickness; and
the metallic reinforcing ring comprises a second wall thickness, less than the first wall thickness.

18. The rolling bearing of claim 11, wherein the rolling bearing is designed as a double-row ball bearing.

19. A method for operating a rolling bearing comprising:
providing the rolling bearing comprising:
a first bearing ring;
a metallic thrust washer held on the first bearing ring;
a second bearing ring;
a metallic reinforcing ring held on the second bearing ring;
a seal operating between the first bearing ring and the second bearing ring;
operating the rolling bearing at a first mechanical load where the first bearing ring rotates relative to the second bearing ring and the metallic thrust washer does not contact the metallic reinforcing ring; and
operating the rolling bearing at a second mechanical load, greater than the first mechanical load, where the metallic reinforcing ring contacts the metallic thrust washer and respective shapes of the metallic reinforcing ring and the metallic thrust washer generate oscillating relative movements between the metallic reinforcing ring and the metallic thrust washer having a frequency higher than a speed of the rolling bearing.

20. The method of claim 19 wherein the oscillating relative movements are oriented predominantly in an axial direction of the rolling bearing.
